(19) United States
(12) Patent Application Publication
(10) Pub. No.: US 2023/0306423 A1
(43) Pub. Date: Sep. 28, 2023

(54) APPARATUSES AND METHODS FOR IMMEDIATE PAYMENT RESPONSE

(71) Applicant: Wells Fargo Bank N.A., San Francisco, CA (US)

(72) Inventors: Daniel Alexander David, Charlotte, NC (US); Hunter Doolittle, Charlotte, NC (US); Shane Duncan Eaton, Charlotte, NC (US); Todd Klapprodt, San Francisco, CA (US); Jeffrey A. Knight, Charlotte, NC (US); Kellie L. Thomas, St. Johns, FL (US); Christina Zikeli, Charlotte, NC (US); Loftlon Worth, Huntersville, NC (US)

(21) Appl. No.: 16/548,235

(22) Filed: Aug. 22, 2019

(51) Int. Cl. G06Q 20/40; G06F 16/2455

(52) U.S. Cl. CPC G06Q 20/40; G06F 16/2455

(57) ABSTRACT

Methods, apparatuses, and computer program products are disclosed for effectuating payment for time-sensitive responses. An example method includes receiving a time-sensitive request for payment from a service provider device, generating an actionable payment notification for a first user device associated with the time-sensitive request for payment, and transmitting the actionable payment notification to the first user device. In an instance in which the computing device receives responsive authorization from the first user device, the method includes transmitting a first real-time payment to the service provider device. In an instance in which the computing device fails to receive responsive authorization from the first user device, the method includes transmitting a payment failure notification to the service provider device.

### TECHNOLOGICAL FIELD

Example embodiments of the present invention relate generally to service delivery and, more particularly, to the use of real-time payments for time-sensitive responses.

### BACKGROUND

Businesses and users often manage a variety of invoices, bills, and the like for services that they provide and/or receive. Each of these invoices and bills may be associated with a respective due date or deadline by which payment must be received by the service provider. Failure to satisfy the outstanding balance by the deadline, however, may result in additional fees, service termination, or the like.

### BRIEF SUMMARY

Traditional methods for funding or otherwise providing payment for services often rely upon conventional payment methods (e.g., credit card payments, debit card payments, automated clearing house (ACH) payments, wire payments, etc.). Funds transferred via these conventional payment methods may satisfy a business or user’s outstanding debts, bills, invoices, etc. by their respective due dates if provided sufficiently in advance of the deadline date. In many instances, however, a business or user may forget to timely pay their invoices/bills, may inadvertently attempt to overdraft an account, or may otherwise require immediate payment to satisfy their obligation or debts in order to avoid an imminent adverse consequence. By way of example, a business may fail to timely pay an invoice associated with a utility (e.g., power, water, etc.) supplied to the business by a service provider. Prior to halting utility service to the business, the service provider may offer a time-sensitive request for payment (e.g., pay the bill now before we turn off the utility). With conventional payment methods, the time associated with the transfer of funds exceeds the time requirement of the time-sensitive request for payment (e.g., a wire payment requires processing time). Furthermore, conventional payment methods also fail to provide adequate assurances to service providers. By way of example, a business may authorize an ACH payment in satisfaction of an outstanding invoice (e.g.., a time-sensitive request), but may later challenge or otherwise revoke the ACH payment. In this way, service providers may bear the risk associated with conventional payments.

To solve these issues and others, example implementations of embodiments of the present invention may utilize irrevocable, real-time payments for time-sensitive requests. In operation, embodiments of the present disclosure may receive a time-sensitive request for payment from a service provider, may generate an actionable payment notification for a first user device associated with the time-sensitive request for payment, and transmit the actionable payment notification to the user device. In an instance in which a responsive authorization from the user device is provided, real-time payments may be transmitted to the service provider device. In instances in which no responsive authorization is received, however, a payment failure notification may be transmitted to the service provider device. In this way, the inventors have identified that the advent of new payment technologies have created a new opportunity for solutions for effectuating payment for time-sensitive requests which were historically unavailable. In doing so, such example implementations confront and solve at least two technical challenges: (1) they provide immediate response to time-sensitive requests for payment, and (2) they reliably ensure irrevocable payment to service providers.

Systems, apparatuses, methods, and computer program products are disclosed herein for effectuating payment for time-sensitive responses. In one embodiment, with reference to the claimed method, a method for effectuating payment for time-sensitive requests may include receiving, via a computing device, a time-sensitive request for payment from a service provider device. The method may further include generating, via account identification circuitry of the computing device, an actionable payment notification for a first user device associated with the time-sensitive request for payment, and transmitting, via payment circuitry of the computing device, the actionable payment notification to the first user device. In an instance in which the computing device receives responsive authorization from the first user device, the method may include transmitting, via the payment circuitry of the computing device, a first real-time payment to the service provider device. In an instance in which the computing device fails to receive responsive authorization from the first user device, the method may include transmitting, via the payment circuity of the computing device, a payment failure notification to the service provider device.

In some embodiments, generating the actionable payment notification may also include querying, via the account identification circuitry of the computing device, an account information database storing one or more account parameters. The method may then include generating, via the account identification circuitry of the computing device, the actionable payment notification based on the account parameters.

In other embodiments, the method may include receiving, via contextual analysis circuitry of the computing device, one or more first contextual parameters of the first user device, and receiving, via the contextual analysis circuitry of the computing device, one or more service contextual parameters of the service provider device. The method may then include generating, via the account identification circuitry of the computing device, the actionable payment notification based on the first contextual parameters and the service contextual parameters.

In some embodiments, the time-sensitive request for payment further include a response timing threshold. In such an embodiment, the method may further include transmitting, via payment circuity of the computing device, a payment failure notification to the service provider device in an instance in which the responsive authorization from the first user device fails to satisfy the response timing threshold.

In other embodiments, the time-sensitive request for payment may further include a payment threshold. In such an embodiment, the method may further include transmitting, via payment circuity of the computing device, a payment failure notification to the service provider device in an instance in which the responsive authorization from the first user device fails to satisfy the payment threshold.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below.

### BRIEF DESCRIPTION OF THE DRAWINGS

Having described certain example embodiments of the present disclosure in general terms above, reference will now be made to the accompanying drawings. The components illustrated in the figures may or may not be present in certain embodiments described herein. Some embodiments may include fewer (or more) components than those shown in the figures.

FIG. 1 illustrates a system diagram including devices that may be involved in some example embodiments described herein.

FIG. 2 illustrates a schematic block diagram of example circuitry that may perform various operations, in accordance with some example embodiments described herein.

FIG. 3 illustrates an example flowchart for effectuating payment for time-sensitive responses, in accordance with some example embodiments described herein.

FIG. 4 illustrates an example flowchart for generating an actionable payment notification, in accordance with some example embodiments described herein.

FIG. 5 illustrates an example flowchart for response timing and payment threshold analysis, in accordance with some example embodiments described herein.

### DETAILED DESCRIPTION

Some embodiments of the present invention will now be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout. As used herein, the description may refer to a real-time payment server as an example “apparatus.” However, elements of the apparatus described herein may be equally applicable to the claimed method and computer program product. Thus, use of any such terms should not be taken to limit the spirit and scope of embodiments of the present invention.

### Definition of Terms

As used herein, the terms “data,” “content,” “information,” “electronic information,” “signal,” “command,” and similar terms may be used interchangeably to refer to data capable of being transmitted, received, and/or stored in accordance with embodiments of the present disclosure. Thus, use of any such terms should not be taken to limit the spirit or scope of embodiments of the present disclosure. Further, where a first computing device is described herein to receive data from a second computing device, it will be appreciated that the data may be received directly from the second computing device or may be received indirectly via one or more intermediary computing devices, such as, for example, one or more servers, relays, routers, network access points, base stations, hosts, and/or the like, sometimes referred to herein as a “network.” Similarly, where a first computing device is described herein as sending data to a second computing device, it will be appreciated that the data may be sent directly to the second computing device or may be sent indirectly via one or more intermediary computing devices, such as, for example, one or more servers, remote servers, cloud-based servers (e.g., cloud utilities), relays, routers, network access points, base stations, hosts, and/or the like.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

As used herein, the phrases “in one embodiment,” “according to one embodiment,” “in some embodiments,” and the like generally refer to the fact that the particular feature, structure, or characteristic following the phrase may be included in at least one embodiment of the present disclosure. Thus, the particular feature, structure, or characteristic may be included in more than one embodiment of the present disclosure such that these phrases do not necessarily refer to the same embodiment.

As used herein, the word “example” is used to mean “serving as an example, instance, or illustration.” Any implementation described herein as “example” is not necessarily to be construed as preferred or advantageous over other implementations.

As used herein, the terms “user device,” “mobile device,” “electronic device” and the like refer to computer hardware that is configured (either physically or by the execution of software) to access one or more services made available by a real-time payment server (e.g., apparatus or computing device of the present disclosure) and, among various other functions, is configured to directly, or indirectly, transmit and receive data. Example user devices may include a smartphone, a tablet computer, a laptop computer, a wearable device (e.g., smart glasses, smart watch, or the like), and the like. In some embodiments, a user device may include a “smart device” that is equipped with a chip or other electronic device that is configured to communicate with the apparatus via Bluetooth, NFC, Wi-Fi, 3G, 4G, 5G, RFID protocols, and the like. By way of a particular example, a user device may be a mobile phone equipped with a Wi-Fi radio that is configured to communicate with a Wi-Fi access point that is in communication with the real-time payment server 200 or other computing devices via a network.

As used herein, the term “service provider device” refers to any object, device, or system which may be in network communication with the real-time payment server, the first user device, and/or the second user device. For example, a service provider device may be an external server or computing device (e.g., associated with a utility company, towing company, banking entity, or the like) that may request, receive, and/or provide data to or from one of the devices described above. By way of example, a service provider device may include a server associated with a utility company that operates to supply one or more utilities to user devices connected thereto. In some embodiments, the service provider device may include a mobile device of a towing company configured to facilitate towing of a vehicle associated with a user (e.g., and associated user device).

As used herein, the term “account information database” refers to a data structure or repository for storing user data, account parameters, and the like. Similarly, the “account parameters” of the account information database may refer to data generated by or relevant to a user device and associated user (e.g., account data, transaction data, purchase data, billing data, or the like). The account information database may be accessible by one or more software applications of the real-time payment server 200.

As used herein, the term “computer-readable medium” refers to non-transitory storage hardware, non-transitory storage device or non-transitory computer system memory that may be accessed by a controller, a microcontroller, a computational system or a module of a computational system to encode thereon computer-executable instructions or software programs. A non-transitory “computer-readable medium” may be accessed by a computational system or a module of a computational system to retrieve and/or execute the computer-executable instructions or software programs encoded on the medium. Exemplary non-transitory computer-readable media may include, but are not limited to, one or more types of hardware memory, non-transitory tangible media (for example, one or more magnetic storage disks, one or more optical disks, one or more USB flash drives), computer system memory or random access memory (such as, DRAM, SRAM, EDO RAM), and the like.

As used herein, description is made to a “real-time payment” transmission or transaction initiated or otherwise caused by the embodiments of the present disclosure. A real-time payment may refer to a substantially simultaneous transfer of irrevocable funds from a sender to a recipient. While described herein as substantially simultaneous or occurring in “real-time,” the present disclosure contemplates that a real-time payment may practically occur over a time frame of several seconds (e.g., or any duration). In some instances, a real-time payment may require additional time (e.g., in order to verify a destination device or account, due to system volume or other technological limitations, etc.) such that the completed transfer of funds requires several minutes or hours. In any event, a real-time payment as described herein refers to an irrevocable transfer of funds at a speed that is substantially faster than traditional payments methods. Additionally, a real-time payment may also refer to a transfer of irrevocable funds that may be immediately accessible and usable by a recipient. Unlike conventional payment methods that may appear in a user’s account (e.g., as a memo-credit or the like) but cannot be used, funds transferred via a real-time payment may be immediately useable by a recipient.

Furthermore, the present disclosure acknowledges that a real-time payment system or RTP® may refer to a particular payment network or digital commerce system owned by The Clearing House (TCH). The embodiments of the present disclosure, however, do not refer to or require a particular payment network or digital commerce system and, instead, refer to the substantially simultaneous and irrevocable transfer of funds as described above.

Having set forth a series of definitions called-upon throughout this application, an example system architecture and example apparatus is described below for implementing example embodiments and features of the present disclosure.

### Device Architecture and Example Apparatus

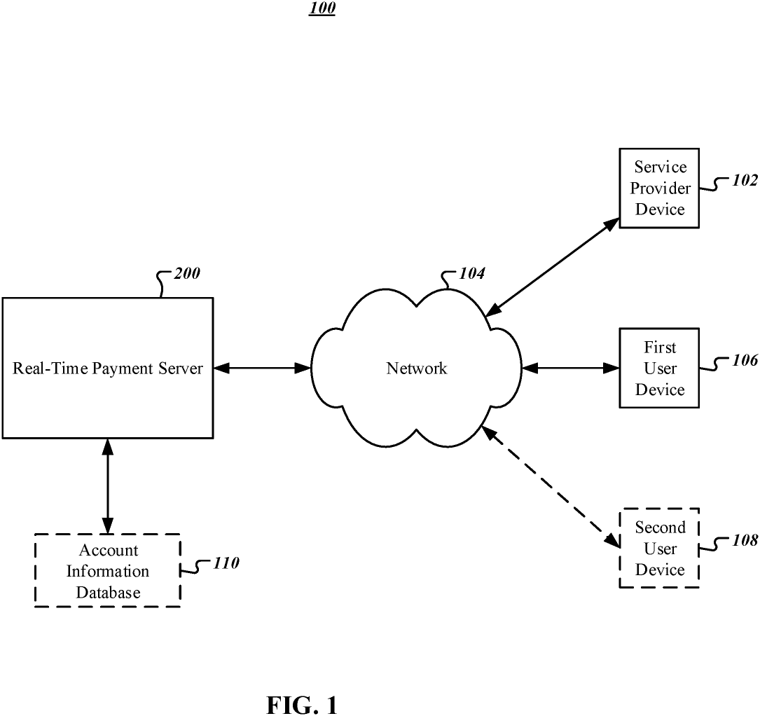

With reference to FIG. 1, an example system 100 is illustrated with an apparatus (e.g., a real-time payment server 200) communicably connected via a network 104 to a service provider device 102, a first user device 106, and, in some embodiments, a second user device 108. The example system 100 may also include an account information database 110 that may be hosted by the real-time payment server 200 or otherwise hosted by devices in communication with the real-time payment server 200.

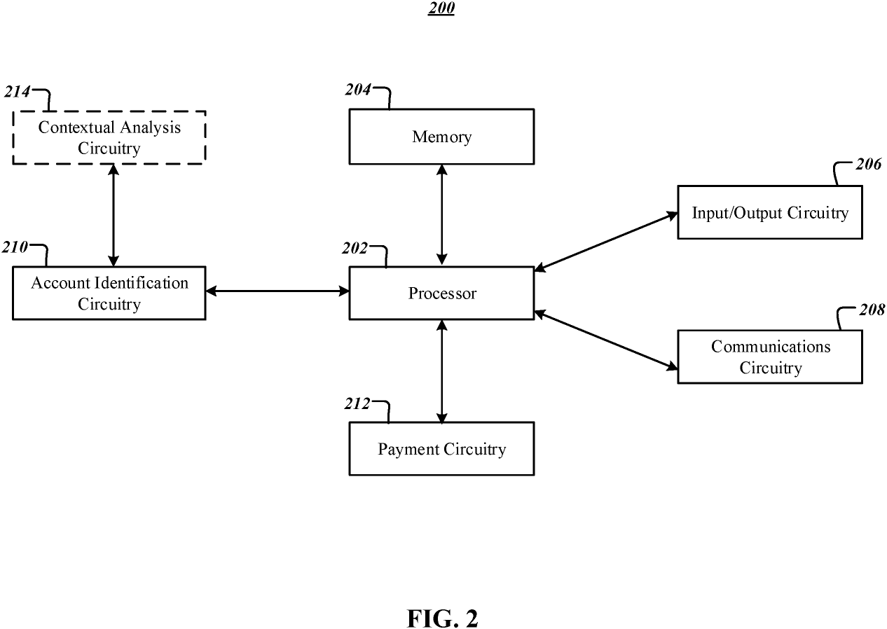

The real-time payment 200 may include circuitry, networked processors, or the like configured to perform some or all of the apparatus-based (e.g., real-time payment server-based) processes described herein, and may be any suitable network server and/or other type of processing device. In this regard, real-time payment server 200 may be embodied by any of a variety of devices. For example, the real-time payment server 200 may be configured to receive/transmit data and may include any of a variety of fixed terminals, such as a server, desktop, or kiosk, or it may comprise any of a variety of mobile terminals, such as a portable digital assistant (PDA), mobile telephone, smartphone, laptop computer, tablet computer, or in some embodiments, a peripheral device that connects to one or more fixed or mobile terminals. Example embodiments contemplated herein may have various form factors and designs but will nevertheless include at least the components illustrated in FIG. 2 and described in connection therewith. In some embodiments, the real-time payment server 200 may be located remotely from the first user device 106, the service provider device 102, the second user device 108, and/or account information database 110, although in other embodiments, the real-time payment server 200 may comprise the first user device 106, the service provider device 102, the second user device 108, and/or the account information database 110. The real-time payment server 200 may, in some embodiments, comprise several servers or computing devices performing interconnected and/or distributed functions. Despite the many arrangements contemplated herein, the real-time payment server 200 is shown and described herein as a single computing device to avoid unnecessarily overcomplicating the disclosure.

The network 104 may include one or more wired and/or wireless communication networks including, for example, a wired or wireless local area network (LAN), personal area network (PAN), metropolitan area network (MAN), wide area network (WAN), or the like, as well as any hardware, software and/or firmware for implementing the one or more networks (e.g., network routers, switches, hubs, etc.). For example, the network 104 may include a cellular telephone, mobile broadband, long term evolution (LTE), GSM/EDGE, UMTS/HSPA, IEEE 802.11, IEEE 802.16, IEEE 802.20, Wi-Fi, dial-up, and/or WiMAX network. Furthermore, the network 104 may include a public network, such as the Internet, a private network, such as an intranet, or combinations thereof, and may utilize a variety of networking protocols now available or later developed including, but not limited to TCP/IP based networking protocols.

The first user device 106 may refer to a user device associated with a first user and may be a cellular telephone (e.g., a smartphone and/or other type of mobile telephone), laptop, tablet, electronic reader, e-book device, media device, wearable, smart glasses, smartwatch, or any combination of the above. Similarly, the second user device 108 may refer to a user device associated with a second user and may also be a cellular telephone (e.g., a smartphone and/or other type of mobile telephone), laptop, tablet, electronic reader, e-book device, media device, wearable, smart glasses, smartwatch, or any combination of the above. Although only a first user device 106 and a second user device 108 are illustrated, the example system 100 may include any number of user devices associated with the same user or any number of respective other users.

The service provider device 102, as defined above, may be associated with any entity (e.g., service provider) that may be in network communication with the real-time payment server 200, the first user device 106, and/or the second user device 108. For example, the service provider device 102 may be a server or computing device (e.g., associated with a utility service, towing company, banking entity, etc. that may request, receive, and/or provide data to or from the first user device 106 and/or the second user device 108 as described above.

The account information database 110 may be stored by any suitable storage device configured to store some or all of the information described herein (e.g., memory 204 of the real-time payment server 200 or a separate memory system separate from the real-time payment server 200, such as one or more database systems, backend data servers, network databases, cloud storage devices, or the like provided by another device (e.g., online application or 3^{rd} party provider) or the first or second user devices 106, 108). The account information database 110 may comprise data received from the real-time payment server 200 (e.g., via a memory 204 and/or processor(s) 202), the first user device 106, or the second user device 108, and the corresponding storage device may thus store this data.

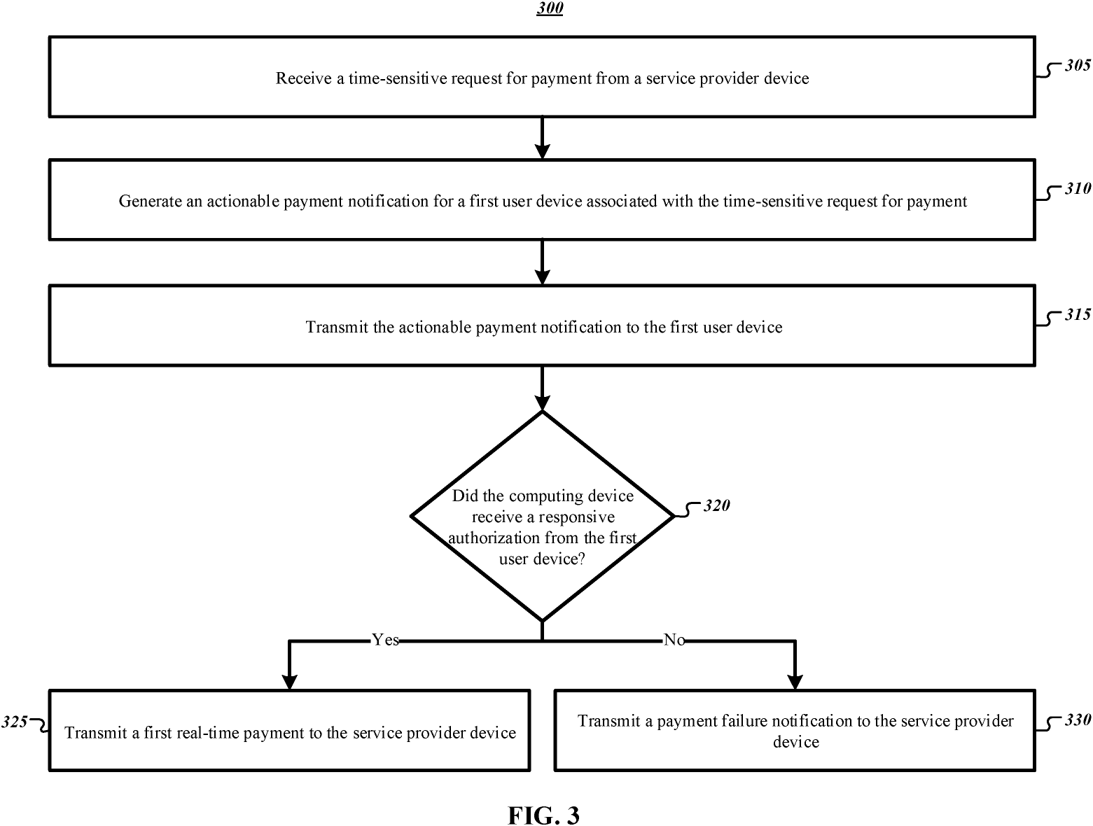

As illustrated in FIG. 2, the real-time payment server 200 may include a processor 202, a memory 204, communications circuitry 208, and input/output circuitry 206. Moreover, the real-time payment server 200 may include account identification circuitry 210, payment circuitry 212, and, in some embodiments, contextual analysis circuitry 214. The real-time payment server 200 may be configured to execute the operations described below in connection with FIGS. 3-5. Although components 202-214 are described in some cases using functional language, it should be understood that the particular implementations necessarily include the use of particular hardware. It should also be understood that certain of these components 202-214 may include similar or common hardware. For example, two sets of circuitry may both leverage use of the same processor 202, memory 204, communications circuitry 208, or the like to perform their associated functions, such that duplicate hardware is not required for each set of circuitry. The use of the term “circuitry” as used herein includes particular hardware configured to perform the functions associated with respective circuitry described herein. As described in the example above, in some embodiments, various elements or components of the circuitry of the real-time payment server 200 may be housed within the first user device 106, the second user device 108, and/or the service provider device 102. It will be understood in this regard that some of the components described in connection with the real-time payment server 200 may be housed within one of these devices, while other components are housed within another of these devices, or by yet another device not expressly illustrated in FIG. 1.

Of course, while the term “circuitry” should be understood broadly to include hardware, in some embodiments, the term “circuitry” may also include software for configuring the hardware. For example, although “circuitry” may include processing circuitry, storage media, network interfaces, input/output devices, and the like, other elements of the real-time payment server 200 may provide or supplement the functionality of particular circuitry.

In some embodiments, the processor 202 (and/or co-processor or any other processing circuitry assisting or otherwise associated with the processor) may be in communication with the memory 204 via a bus for passing information among components of the real-time payment server 200. The memory 204 may be non-transitory and may include, for example, one or more volatile and/or non-volatile memories. In other words, for example, the memory may be an electronic storage device (e.g., a non-transitory computer readable storage medium). The memory 204 may be configured to store information, data, content, applications, instructions, or the like, for enabling the real-time payment server 200 to carry out various functions in accordance with example embodiments of the present invention.

The processor 202 may be embodied in a number of different ways and may, for example, include one or more processing devices configured to perform independently. Additionally, or alternatively, the processor may include one or more processors configured in tandem via a bus to enable independent execution of instructions, pipelining, and/or multithreading. The use of the term “processing circuitry” may be understood to include a single core processor, a multi-core processor, multiple processors internal to the real-time payment server, and/or remote or “cloud” processors.

In an example embodiment, the processor 202 may be configured to execute instructions stored in the memory 204 or otherwise accessible to the processor 202. Alternatively, or additionally, the processor 202 may be configured to execute hard-coded functionality. As such, whether configured by hardware or by a combination of hardware with software, the processor 202 may represent an entity (e.g., physically embodied in circuitry) capable of performing operations according to an embodiment of the present invention while configured accordingly. Alternatively, as another example, when the processor 202 is embodied as an executor of software instructions, the instructions may specifically configure the processor 202 to perform the algorithms and/or operations described herein when the instructions are executed.

The real-time payment server 200 further includes input/output circuitry 206 that may, in turn, be in communication with processor 202 to provide output to a user and to receive input from a user, user device, or another source. In this regard, the input/output circuitry 206 may comprise a display that may be manipulated by a mobile application. In some embodiments, the input/output circuitry 206 may also include additional functionality such as a keyboard, a mouse, a joystick, a touch screen, touch areas, soft keys, a microphone, a speaker, or other input/output mechanisms. The processor 202 and/or user interface circuitry comprising the processor 202 may be configured to control one or more functions of a display through computer program instructions (e.g., software and/or firmware) stored on a memory accessible to the processor (e.g., memory 204, and/or the like).

The communications circuitry 208 may be any means such as a device or circuitry embodied in either hardware or a combination of hardware and software that is configured to receive and/or transmit data from/to a network and/or any other device, circuitry, or module in communication with the real-time payment server 200. In this regard, the communications circuitry 208 may include, for example, a network interface for enabling communications with a wired or wireless communication network. For example, the communications circuitry 208 may include one or more network interface cards, antennae, buses, switches, routers, modems, and supporting hardware and/or software, or any other device suitable for enabling communications via a network. Additionally, or alternatively, the communication interface may include the circuitry for interacting with the antenna(s) to cause transmission of signals via the antenna(s) or to handle receipt of signals received via the antenna(s). These signals may be transmitted by the real-time payment server 200 using any of a number of wireless personal area network (PAN) technologies, such as Bluetooth^{®} v1.0 through v3.0, Bluetooth Low Energy (BLE), infrared wireless (e.g., IrDA), ultra-wideband (UWB), induction wireless transmission, or the like. In addition, it should be understood that these signals may be transmitted using Wi-Fi, Near Field Communications (NFC), Worldwide Interoperability for Microwave Access (WiMAX) or other proximity-based communications protocols.

The account identification circuitry 210 includes hardware components designed to generate an actionable payment notification for user devices associated with a time-sensitive request for payment. The account identification circuitry 210 may utilize processing circuitry, such as the processor 202, to perform its corresponding operations, and may utilize memory 204 to store collected information. By way of example, in some instances, the account identification circuitry 210 may query the account information database 110 to receive one or more account parameters. The account identification circuitry 210 may generate the actionable payment notification based on the account parameters. In some embodiments, the account identification circuitry 210 may further comprise contextual analysis circuitry 214. The contextual analysis circuitry 214 may be configured to receive contextual parameters associated with user devices (e.g., first user device 106) and/or service provider devices (e.g. service provider device 102). The contextual analysis circuitry 214 may further be configured to generate the actionable payment notification based on the first contextual parameters and the service contextual parameters.

The payment circuitry 212 includes hardware components designed to generate and transmit real-time payments. The payment circuitry 212 may be configured to, in an instance in which the real-time payment server 200 receives responsive authorization from a user device (e.g., first user device 106), transmit a first real-time payment to a service provider device 102. The payment circuitry 212 may utilize processing circuitry, such as the processor 202, to perform its corresponding operations, and may utilize memory 204 to store collected information.

It should also be appreciated that, in some embodiments, the account identification circuitry 210, payment circuitry 212, or contextual analysis circuitry 214, may include a separate processor, specially configured field programmable gate array (FPGA), or application specific interface circuit (ASIC) to perform its corresponding functions.

In addition, computer program instructions and/or other type of code may be loaded onto a computer, processor or other programmable risk maintenance server’s circuitry to produce a machine, such that the computer, processor other programmable circuitry that execute the code on the machine create the means for implementing the various functions, including those described in connection with the components of real-time payment server 200.

As described above and as will be appreciated based on this disclosure, embodiments of the present invention may be configured as systems, methods, mobile devices, and the like. Accordingly, embodiments may comprise various means including entirely of hardware or any combination of software with hardware. Furthermore, embodiments may take the form of a computer program product comprising instructions stored on at least one non-transitory computer-readable storage medium (e.g., computer software stored on a hardware device). Any suitable computer-readable storage medium may be utilized including non-transitory hard disks, CD-ROMs, flash memory, optical storage devices, or magnetic storage devices.

### Example Operations for Payment for Time-Sensitive Responses

FIG. 3 illustrates a flowchart containing a series of operations for effectuating payment for time-sensitive responses. The operations illustrated in FIG. 3 may, for example, be performed by, with the assistance of, and/or under the control of an apparatus (e.g., real-time payment server 200), as described above. In this regard, performance of the operations may invoke one or more of processor 202, memory 204, input/output circuitry 206, communications circuitry 208, account identification circuitry 210, payment circuitry 212, and/or contextual analysis circuitry 214.

As shown in operation 305, the apparatus (e.g., real-time payment server 200) includes means, such as input/output circuitry 206, communications circuitry 208, or the like, for receiving a time sensitive request for a payment from a service provider device 102. In some example embodiments, the communications circuitry 208 may receive a request for payment from the service provider device 102 that includes information regarding a first user device 106 and/or a second user device 108. In such an embodiment, the request for payment may include account details (e.g., user name, user account information, user address, etc.) associated with a user device (e.g., and an associated user). In other embodiments, the communications circuitry 208 may receive a time-sensitive request for payment from the service provider device 102 that does not include necessary information regarding a user device and associated user.

By way of example, in an instance in which the service provider device 102 corresponds to a utility service provider, the time-sensitive request for payment may include account information associated with the first user and associated first user device 106. In particular, the service provider device 102 may, from a prior request for payment (e.g., invoice, bill, etc.) and/or from a prior account set up procedures, contain account information associated with the first user and first user device 106. In an alternative embodiment, such as in an instance in which the service provider device 102 corresponds to a mobile device of a towing company, the service provider device 102 may not have sufficient account information for the user and associated first user device 106. By way of continued example, in an instance in which a user’s vehicle (e.g., associated with a first user and first user device 106) is, for example, booted for towing, the service provider device 102 may allow the user and associated first user device 106 to transmit immediate payment in satisfaction of the overdue payments as described hereafter. In such an example, the service provider device 102 may only have access to the user’s vehicle information, the user’s name, or the like.

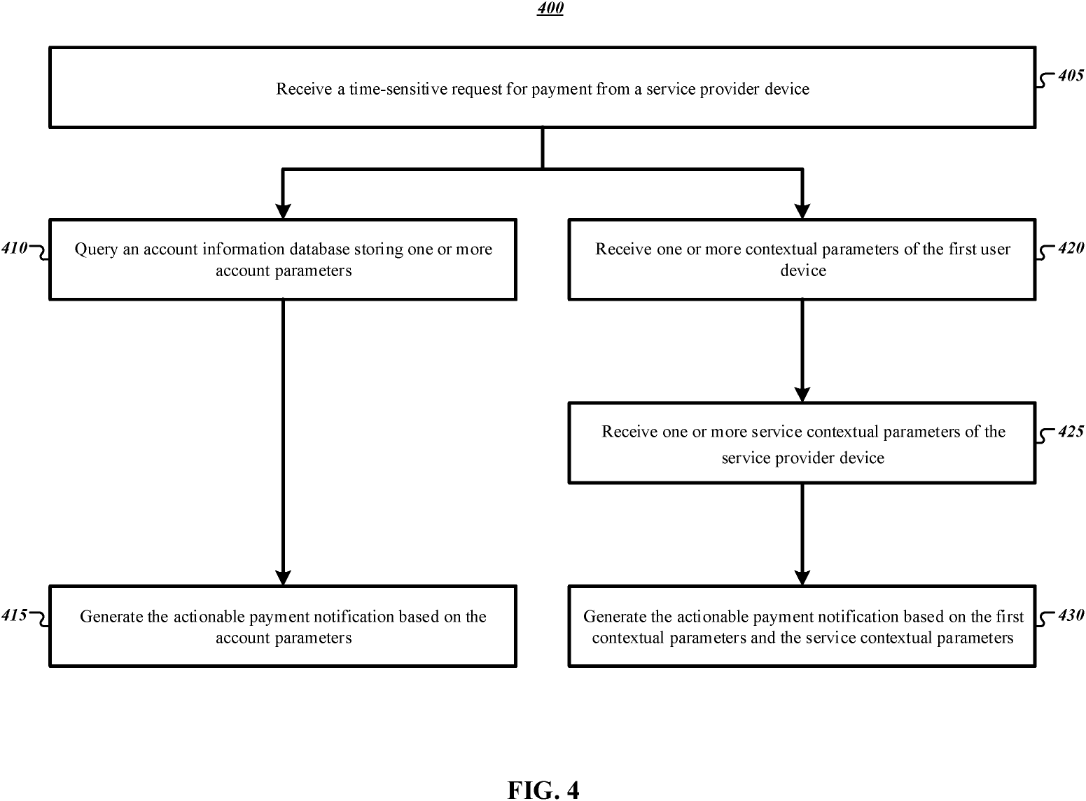

Thereafter, as shown in operation 310, the apparatus (e.g., real-time payment server 200) includes means, such as input/output circuitry 206, account identification circuitry 210, contextual analysis circuitry 214, or the like, generating an actionable payment notification for a first user device 106 associated with the time-sensitive request for payment. As described above, one or more user devices (e.g., the first user device 106) may be communicably coupled with the service provider device 102 via the network 104 such that the user devices (e.g., first user device 106) may receive services (e.g., periodically, consistently, or any combination thereof) facilitated or provided by the service provider device 102. By way of example, the first user device 106 (e.g., or a location, entity, or the like associated with the first user device 106) may be provided access to electrical power offered by a utility provider and associated with the service provider device 102. As described hereafter with reference to FIG. 4, the real-time payment server 200 may be configured to generate an actionable payment notification for the first user device 106 by receiving identifying user data from the service provider device 102 with the time-sensitive request for payment as described above with reference to operation 305 and/or may query an account information database 110 as described hereafter.

As described above, in other embodiments, one or more users associated with user devices (e.g., the first user device 106) may receive a service provided only with regard to a particular, independent interaction. By way of continued example, in an instance in which a user’s vehicle (e.g., associated with a first user and first user device 106) is, for example, booted for towing, the service provider device 102 may allow the user and associated first user device 106 to transmit immediate payment in satisfaction of the overdue invoice. In such an example, the service provider device 102 may only have access to limited information (e.g., the user’s vehicle information, vehicle location, or the like). As described hereafter with reference to FIG. 4, the real-time payment server 200 may, in some embodiments, receive one or more contextual parameters of the first user device 106 and/or the service provider device 102 in order to generate an actionable payment notification based upon the contextual parameters. While the operations of FIG. 3 are described herein with reference to the first user device 106, the present disclosure contemplates that any number of user devices (e.g., second user device 108) may also simultaneously receive services associated with the service provider device 102 and or be associated with a time-sensitive request for payment. By way of example, the service provider device 102 may batch, compile, or otherwise group time-sensitive requests for payment (e.g., all booted vehicles in a particular location, all delinquent utility recipients in an area, etc.) and transmit respective time-sensitive requests for payment associated with each user device.

Thereafter, as shown in operation 315, the apparatus (e.g., real-time payment server 200) includes means, such as processor 202, payment circuitry 212, or the like, for transmitting an actionable payment notification to the first user device 106. As described above, in some embodiments, the request for payment received from the service provider device 102 at operation 305 may include data identifying the first user device 106 (e.g., account information, user address, etc.). In such an embodiment, the time-sensitive request for payment may include or otherwise facilitate generation of an actionable payment notification for transmission to the first user device 106. For example, the service provider device 102 may prepare an actionable payment notification (e.g., an invoice with payment input for such an embodiment) based upon user data associated with the first user device 106 (e.g., user name, address, account information, etc.). In such an embodiment, the real-time payment server 200 may receive the time-sensitive request for payment and actionable payment notification and transmit the actionable payment notification to the first user device 106.

In some instances, however, the time-sensitive request for payment from the service provider device 102 may not include the requisite user information to generate an actionable payment notification. As such, the real-time payment server 200 may, as described hereafter with reference to FIG. 4, generate an actionable payment notification for the first user device 106 associated with the time-sensitive request for payment. For example, the real-time payment server 200 may analyze one or more contextual parameters of the first user device 106 (e.g., location data, device proximity data, internet protocol (IP) data, or the like) to identify one or more account parameters of the first user device 106. In such an embodiment, the real-time payment server 200 may then generate an actionable payment notification for transmission to the first user device 106.

The actionable payment notifications as described herein may refer to a communication (e.g., email, banner notification, text message, or the like) to which a user that includes one or more inputs for user response. For example, the actionable payment notification may, in some embodiments, include a text message transmitted by the real-time payment server 200 to the first user device 106 that includes a responsive payment input (e.g., payment link, input button, etc.) configured to authorize a real-time payment. In some embodiments, the actionable payment notification may include a user input (e.g., “authorize payment?”) that, when selected, transmits a responsive authorization to the real-time payment server 200. In other embodiments, the actionable payment notification may include a plurality of user inputs. In such an embodiment, the plurality of user inputs may include options to authorize payment as well as options to refuse authorization. In other embodiments, the plurality of user inputs may provide options for authorizing real-time payments of varying amounts. In some still further embodiments, the actionable payment notification may allow for a free text user input (e.g., “insert real-time payment amount”) such that the user may authorize a real-time payment of a particular amount. While described herein as an actionable payment notification, the embodiments of the present disclosure contemplate that any form of communication (e.g., pushed notification, text message, direct message into user account, banner notification, or the like) may be used to authorize a real-time payment by the real-time payment server 200.

Thereafter, as shown in operation 320, the apparatus (e.g., real-time payment server 200) includes means, such as the processor 202, the communications circuitry 208, or the like, or the like, for determining if the real-time payment server 200 received a responsive authorization from the first user device 106. As described above, in some embodiments the actionable payment notification may include an input option that, when selected, transmits an instruction that refuses authorization. In such an embodiment, the real-time payment server 200 may receive explicit instructions refusing to authorize a real-time payment and proceed to operation 330 as described hereafter. In other embodiments, the actionable payment notification may only include an option to authorize the real-time payment and/or a user associated with the first user device 106 may fail to take any action (e.g., fail to respond to the actionable payment notification). In such an embodiment, the real-time payment server 200 may, following the expiration of a response time period, proceed to operation 330 as described hereafter.

In some embodiments, as shown in operation 325, the apparatus (e.g., real-time payment server 200) includes means, such as processor 202, memory 204, payment circuitry 212, or the like, for transmitting a first real-time payment to the service provider device 102. As described above, in an instance in which the real-time payment server 200 receives a responsive authorization from the first user device 106, the payment circuitry 212 may transmit (e.g., or cause transmission of) a real-time payment to the service provider device 102. Based upon the input from the first user, the type of actionable payment notification, etc., the real-time payment server 200 may, in some embodiments, transmit a real-time payment to the service provider device 102 in full satisfaction of the request for payment received at operation 305. As would be evident to one of ordinary skill in the art in light of the present disclosure, the real-time payment may serve as an instantaneous and irrevocable payment to the service provider device 102 in order to prevent immediate adverse consequences (e.g., halting of utility services, repossession of vehicle, etc.) In this way, the service provider device 102 may rely upon the irrevocable nature of the real-time payment in continuing to provide the respective service to the first user device 106.

In an instance in which the real-time payment server 200 fails to receive responsive authorization from the first user device, as shown in operation 330, the apparatus (e.g., real-time payment server 200) includes means, such as processor 202, communications circuitry 208, payment circuitry 212, or the like, for transmitting a payment failure notification to the service provider device 102. By way of example, in some embodiments, the real-time payment server 200 may transmit a payment failure notification with instructions to the service provider device 102 causing the service provider device 102 to halt service of a particular utility to a user (e.g., one or more locations associated with the first user and first user device 106). In other embodiments, the transmission of the payment failure notification may indicate to the service provider device 102 of the ability to proceed with immediate adverse consequences. For example, in an instance in which the service provider device 102 is associated with a towing company, the payment failure notification may indicate to the towing company of the ability to proceed with repossession of the user’s vehicle.

Turning next to FIG. 4, a flowchart is shown for generating an actionable payment notification. The operations illustrated in FIG. 4 may, for example, be performed by, with the assistance of, and/or under the control of an apparatus (e.g., real-time payment server 200), as described above. In this regard, performance of the operations may invoke one or more of processor 202, memory 204, input/output circuitry 206, communications circuitry 208, account identification circuitry 210, payment circuitry 212, and/or contextual analysis circuitry 214.

As shown in operation 405, the apparatus (e.g., real-time payment server 200) includes means, such as input/output circuitry 206, communications circuitry 208, or the like, for receiving a time-sensitive request for a payment associated with a service provider device 102. As described above with reference to FIG. 3, the communications circuitry 208 may receive a time-sensitive request for payment from the service provider device 102 that includes information regarding a first user device 106 and/or a second user device 108. In some embodiments, the time-sensitive request for payment may include account details (e.g., user name, user account information, user address, etc.) associated with a user device (e.g., and an associated user). In other embodiments, the communications circuitry 208 may receive a time-sensitive request for payment from the service provider device 102 that does not include information regarding the user device (e.g., repossession of a user’s vehicle may allow access to limited information of the user).

Thereafter, as shown in operations 410, 415 the apparatus (e.g., real-time payment server 200) includes means, such as processor 202, account identification circuitry 210, or the like, for querying an account information database 110 storing one or more account parameters and identifying the first user device 106 based upon the one or more account parameters. As described above, in some embodiments, the time-sensitive request for payment received at operation 405 may include account information associated with the first user and first user device 106. By way of example, the time-sensitive request for payment may include, from an account set up procedure, prior user input, or the like, user account information such that the account identification circuitry 210 may identify the first user device 106 based upon the time-sensitive request for payment. In other embodiments, however, the request for payment may not provide necessary information related to the first user and associated first user device 106. As such, the real-time payment server 200 may query an account information database 110 storing one or more account parameters.

For embodiments in which a service provider device 102 is a utility service provider or similar service provider (e.g., any service provider or entity with access to account information of the first user and the first user device 106), the time-sensitive request for payment may only identify a particular user or user device (e.g., first user device 106) without account information. As such, the account identification circuitry 210 may query the account information database 110 to access and retrieve one or more account parameters. The one or more account parameters may include usernames, account locations, billing information, or the like. By way of a more particular example, the account identification circuitry 210 may query the account information database 110 (e.g., or other data repository, Zelle®, EWS, or the like) to identify an account associated with the first user device 106 in an associated financial institution. Based upon the account information for the first user and associated first user device 106 (e.g., account numbers, user phone numbers, user emails, etc.), the account identification circuitry 210 may generate the actionable payment notification based on the account parameters at operation 415. As such, the actionable payment notification as described above may be transmitted to the first user device 106 as any form of communication (e.g., text message, banner notification, or the like) based upon the intended application, priority, etc.

In some instances, however, the time-sensitive request for payment from the service provider device 102 may not include the requisite user information or the account information database 110 described above and may not include adequate user information to generate the actionable payment notification. With continued reference to a service provider device 102 associated with a towing company, a first user associated with the first user device 106 may fail to properly respond to an invoice related to the user’s vehicle. As such, a towing company (e.g., and associated service provider device 102) may, prior to imminently repossessing the vehicle, transmit a time-sensitive request for payment associated with the delinquent payments for the vehicle (e.g., associated with the first user device 106) as described at operation 405. As such, the apparatus (e.g., real-time payment server 200) includes means, such as processor 202, account identification circuitry 210, contextual analysis circuitry 214, or the like, for receiving one or more contextual parameters (e.g., location data, device proximity data, internet protocol (IP) data, or the like) of the first user device 106 at operation 420 and receiving one or more service contextual parameters (e.g., location data, device proximity data, internet protocol (IP) data, or the like) of the service provider device 102 at operation 425.

By way of example, the contextual analysis circuitry 214, in some embodiments, may receive contextual parameters associated with the location data of the first user device 106 and/or the service provider device 102 at operations 420, 425. By way of example, the real-time payment server 200 may receive location data from the first user device 106 (e.g., global positioning system (GPS) data from a mobile device, an internet protocol (IP) address of the mobile device, etc.) indicating the location of the first user. Similarly, the contextual analysis circuitry 214 may receive location data from the service provider device 102 (e.g., with the request for payment or otherwise) and compare the respective locations of the first user device 106 and the service provider device 102. In an instance in which the location data of the first user device 106 sufficiently corresponds to the location of the service provider device 102 (e.g., within one or more proximity thresholds), the account identification circuitry 210 may generate the actionable payment notification based on the first contextual parameters and the service contextual parameters (e.g., location data) at operation 430. Said differently, the account identification circuitry 110 may, in such an embodiment, receive the necessary account information or parameters for generating an actionable payment notification from the proximate first user device 106 and the service provider device 102.

As would be evident to one of ordinary skill in the art in light of the present disclosure, instances in which the contextual analysis circuitry 214 relies upon location data of the first user device 106 and the service provider device 102 may be limited to instances in which the first user and associated user device are physically present during, for example, repossessing the user’s vehicle. As such, the embodiments of the present application contemplate that any contextual parameters of the first user device 106 and the service provider device 102 may be used by the real-time payment server 200 based upon the intended application.

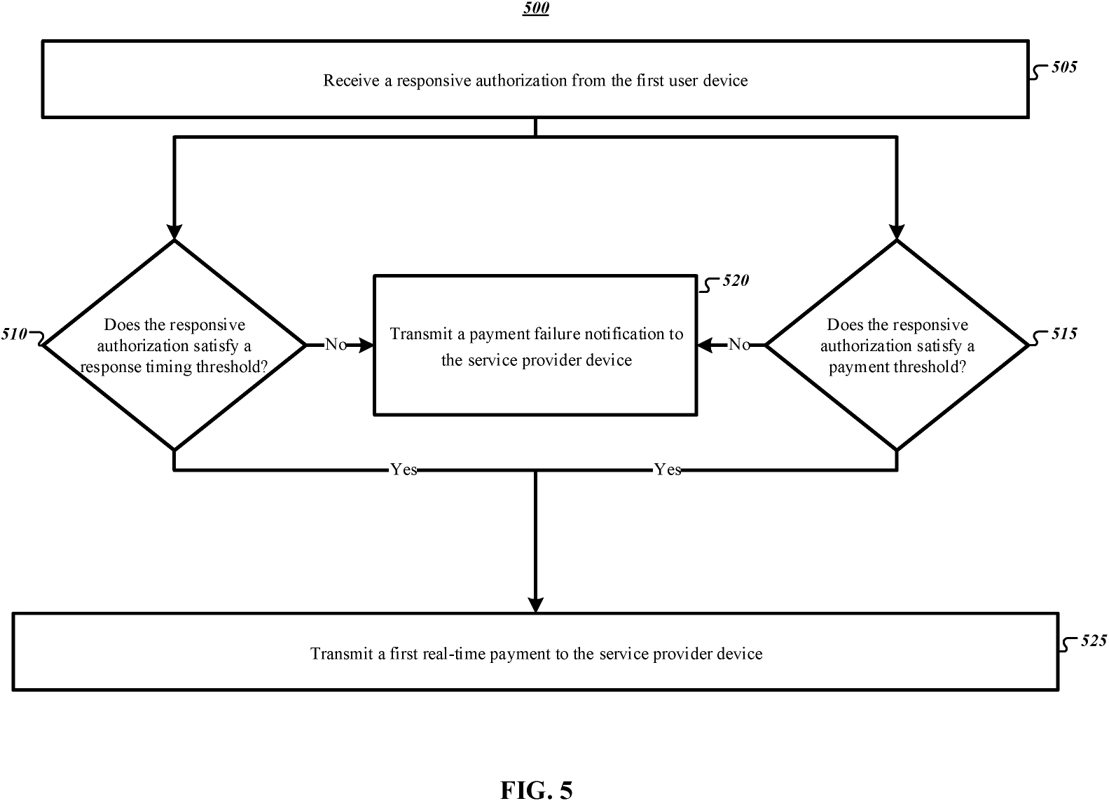

Turning next to FIG. 5, a flowchart is shown for response timing and payment threshold analysis. The operations illustrated in FIG. 5 may, for example, be performed by, with the assistance of, and/or under the control of an apparatus (e.g., real-time payment server 200), as described above. In this regard, performance of the operations may invoke one or more of processor 202, memory 204, input/output circuitry 206, communications circuitry 208, account identification circuitry 210, payment circuitry 212, and/or contextual analysis circuitry 214.

As shown in operation 505, the apparatus (e.g., real-time payment server 200) includes means, such as input/output circuitry 206, communications circuitry 208, or the like, for receiving a responsive authorization from the first user device 106. As would be evident to one of ordinary skill in the art in light of the present disclosure, in some instances, a user associated with the first user device 106 may provide responsive authorization in response to the actionable payment notification as described above. However, in some instances, the responsive authorization may fail to satisfy the outstanding balance due to the service provider (e.g., service provider device 102) and/or fail to be provided in sufficient time given the nature of the time-sensitive request.

Thereafter, as shown in operation 510, the apparatus (e.g., real-time payment server 200) includes means, such as the processor 202, the payment circuitry 212, or the like, or the like, for determining if the responsive authorization satisfies a response timing threshold. As described above, the request for payment described herein is time-sensitive in that a response (e.g., responsive authorization) must be received by the service provider device 102 within a defined time period in order to prevent adverse consequences. As such, at operation 515, the real-time payment server 200 may analyze the response timing of the responsive authorization and compare this timing with the response timing threshold (e.g., associated with the time-sensitive request for payment). In an instance in which the timing of the responsive authorization fails to satisfy the response timing threshold (e.g., the responsive authorization is received too late), the payment circuitry 212 may transmit a payment failure notification to the service provider device at operation 520. As described above with reference to operation 330, the real-time payment server 200 may transmit a payment failure notification with instructions to the service provider device 102 causing the service provider device 102 to halt service of a particular utility to a user (e.g., one or more locations associated with the first user and first user device 106). In other embodiments, the transmission of the payment failure notification may indicate to the service provider device 102 of the ability to proceed with immediate adverse consequences.

In an instance in which the timing of the responsive authorization satisfies the response timing threshold (e.g., the responsive authorization is received in sufficient time), the payment circuitry 212 may transmit a first real-time payment to the service provider device 102 at operation 525. As described above with reference to operation 325, in an instance in which the real-time payment server 200 receives a responsive authorization from the first user device 106, the payment circuitry 212 may transmit (e.g., or cause transmission of) a real-time payment to the service provider device 102. Based upon the input from the first user, the type of actionable payment notification, etc., the real-time payment server 200 may, in some embodiments, transmit a real-time payment to the service provider device 102 in full satisfaction of the request for payment received at operation 505. As would be evident to one of ordinary skill in the art in light of the present disclosure, the real-time payment may serve as an instantaneous and irrevocable payment to the service provider device 102 in order to prevent immediate adverse consequences (e.g., halting of utility services, repossession of vehicle, etc.).

As shown in operation 515, the apparatus (e.g., real-time payment server 200) includes means, such as the processor 202, the payment circuitry 212, or the like, or the like, for determining if the responsive authorization satisfies a payment threshold. As described above, the request for payment described herein may relate to an outstanding invoice, bill, or the like that must be satisfied. As such, the responsive authorization received at operation 505 must be authorize a real-time payment that exceeds the payment threshold of the service provider device 102 in order to prevent adverse consequences. As such, at operation 515, the real-time payment server 200 may analyze the amount of the responsive authorization received at operation 505 and compare this amount with a payment threshold (e.g., associated with the time-sensitive request for payment). In an instance in which the amount of the responsive authorization fails to satisfy the payment threshold (e.g., the responsive authorization is insufficient), the payment circuitry 212 may transmit a payment failure notification to the service provider device 102 at operation 520 as described above.

In an instance in which the amount of the responsive authorization satisfies the payment threshold, the payment circuitry 212 may transmit a first real-time payment to the service provider device 102 at operation 525. As described above, in an instance in which the real-time payment server 200 receives a responsive authorization from the first user device 106, the payment circuitry 212 may transmit (e.g., or cause transmission of) a real-time payment to the service provider device 102. As above, the real-time payment may serve as an instantaneous and irrevocable payment to the service provider device 102 in order to prevent immediate adverse consequences (e.g., halting of utility services, repossession of vehicle, etc.).

As described above, various technical challenges are surmounted via technical solutions contemplated herein. For instance, example implementations of embodiments of the present invention utilize irrevocable, real-time payments for time-sensitive requests. In operation, embodiments of the present disclosure may receive a time-sensitive request for payment from a service provider, may generate an actionable payment notification for a first user device associated with the time-sensitive request for payment, and transmit the actionable payment notification to the user device. In an instance in which a responsive authorization from the user device is provided, real-time payments may be transmitted to the service provider device. In instances in which no responsive authorization is received, however, a payment failure notification may be transmitted to the service provider device. In this way, the inventors have identified that the advent of new payment technologies have created a new opportunity for solutions for effectuating payment for time-sensitive requests which were historically unavailable. In doing so, such example implementations confront and solve at least two technical challenges: (1) they provide immediate response to time-sensitive requests for payment, and (2) they reliably ensure irrevocable payment to service providers.

FIGS. 3-5 thus illustrate flowcharts describing the operation of apparatuses, methods, and computer program products according to example embodiments contemplated herein. It will be understood that each flowchart block, and combinations of flowchart blocks, may be implemented by various means, such as hardware, firmware, processor, circuitry, and/or other devices associated with execution of software including one or more computer program instructions. For example, one or more of the operations described above may be implemented by an apparatus executing computer program instructions. In this regard, the computer program instructions may be stored by a memory 204 of the real-time payment server 200 and executed by a processor 202 of the real-time payment server 200. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture, the execution of which implements the functions specified in the flowchart blocks. The computer program instructions may also be loaded onto a computer or other programmable apparatus to cause a series of operations to be performed on the computer or other programmable apparatus to produce a computer-implemented process such that the instructions executed on the computer or other programmable apparatus provide operations for implementing the functions specified in the flowchart blocks.

The flowchart blocks support combinations of means for performing the specified functions and combinations of operations for performing the specified functions. It will be understood that one or more blocks of the flowcharts, and combinations of blocks in the flowcharts, can be implemented by special purpose hardware-based computer systems which perform the specified functions, or combinations of special purpose hardware with computer instructions.

### Conclusion

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for halting one or more service provider services provided to a first user, the method comprising:
receiving, via a computing device, a time-sensitive request for payment from a service provider device, wherein the service provider device provides one or more services to a user associated with a first user device;
querying, via account identification circuitry of the computing device, an account information database to retrieve one or more account parameters associated with a user account of the user associated with the first user device,
generating, via the account identification circuitry of the computing device, an actionable payment notification for the first user device associated with the time-sensitive request for payment, wherein the actionable payment notification is based at least in part on the one or more account parameters ;
transmitting, via payment circuitry of the computing device, the actionable payment notification to the first user device, wherein the actionable payment notification includes one or more inputs for a user response; and
transmitting, via the payment circuitry of the computing device, a payment failure notification to the service provider device in response to the computing device failing to receive responsive authorization from the first user device, wherein i) the payment failure notification includes instructions to halt the one or more services and ii) transmission of the payment failure notification causes the service provider device to automatically halt the one or more services.

2. (canceled)

3. The method according to claim 1, further comprising:
receiving, via contextual analysis circuitry of the computing device, one or more first contextual parameters including at least location data of the first user device;
receiving, via the contextual analysis circuitry of the computing device, one or more service contextual parameters including at least location data of the service provider device;
determining whether the location data of the first user device corresponds to the location data of the service provider device within one or more proximity thresholds; and
generating, via the account identification circuitry of the computing device, the actionable payment notification further based on the one or more first contextual parameters and the one or more service contextual parameters.

4. The method according to claim 1, wherein the time-sensitive request for payment further comprises a response timing threshold defined by a maximum duration of time between receipt for the time-sensitive request for payment and a responsive authorization from the first user device.

5. The method according to claim 4, further comprising transmitting, via the payment circuitry of the computing device, the payment failure notification to the service provider device in an instance in which the responsive authorization from the first user device fails to satisfy the response timing threshold.

6. The method according to claim 1, wherein the time-sensitive request for payment further comprises a payment threshold.

7. The method according to claim 6, further comprising transmitting, via the payment circuitry of the computing device, the payment failure notification to the service provider device in an instance in which the responsive authorization from the first user device fails to satisfy the payment threshold.

8. An apparatus for halting one or more service provider services provided to a first user, the apparatus comprising:
communications circuitry configured to receive a time-sensitive request for payment from a service provider device, wherein the service provider device provides one or more services to a user associated with a first user device;
account identification circuitry configured to:
query an account information database to retrieve one or more account parameters associated with a user account of the user associated with the first user device, and
generate an actionable payment notification for the first user device associated with the time-sensitive request for payment, wherein the actionable payment notification is based at least in part on the one or more account parameters ; and
payment circuitry configured to:
transmit the actionable payment notification to the first user device, wherein the actionable payment notification includes one or more inputs for a user response, and
transmit a payment failure notification to the service provider device in response to failing to receive responsive authorization from the first user device, wherein i) the payment failure notification includes instructions to halt the one or more services and ii) transmission of the payment failure notification causes the service provider device to automatically halt the one or more services.

9. (canceled)

10. The apparatus according to claim 8, further comprising contextual analysis circuitry configured to:
receive one or more first contextual parameters including at least location data of the first user device;
receive one or more service contextual parameters including at least location data of the service provider device;
determine whether the location data of the first user device corresponds to the location data of the service provider device within one or more proximity thresholds; and
generate the actionable payment notification further based on the one or more first contextual parameters and the one or more service contextual parameters.

11. The apparatus according to claim 8, wherein the time-sensitive request for payment further comprises a response timing threshold defined by a maximum duration of time between receipt for the time-sensitive request for payment and a responsive authorization from the first user device.

12. The apparatus according to claim 11, wherein the payment circuitry is further configured to transmit the payment failure notification to the service provider device in an instance in which the responsive authorization from the first user device fails to satisfy the response timing threshold.

13. The apparatus according to claim 8, wherein the time-sensitive request for payment further comprises a payment threshold.

14. The apparatus according to claim 13, wherein the payment circuitry is further configured to transmit the payment failure notification to the service provider device in an instance in which the responsive authorization from the first user device fails to satisfy the payment threshold.

15. A non-transitory computer-readable storage medium for using an apparatus to halt one or more service provider services provided to a first user, the non-transitory computer-readable storage medium storing computer-executable instructions that, when executed, cause the apparatus to:
receive a time-sensitive request for payment from a service provider device, wherein the service provider device provides one or more services to a user associated with a first user device;
query an account information database to retrieve one or more account parameters associated with a user account of the user associated with the first user device;
generate an actionable payment notification for the first user device associated with the time-sensitive request for payment, wherein the actionable payment notification is based at least in part on the one or more account parameters and one or more of the one or more account parameters is determined based on the query of the account information database ;
transmit the actionable payment notification to the first user device, wherein the actionable payment notification includes one or more inputs for a user response; and
transmit a payment failure notification to the service provider device in response to failing to receive responsive authorization from the first user device, wherein i) the payment failure notification includes instructions to halt the one or more services and ii) transmission of the payment failure notification causes the service provider device to automatically halt the one or more services.

16. (canceled)

17. The non-transitory computer-readable storage medium according to claim 15, wherein the computer-executable instructions, when executed, further cause the apparatus to:
receive one or more first contextual parameters including at least location data of the first user device;
receive one or more service contextual parameters including at least location data of the service provider device;
determine whether the location data of the first user device corresponds to the location data of the service provider device within one or more proximity thresholds; and
generate the actionable payment notification further based on the one or more first contextual parameters and the one or more service contextual parameters.

18. The non-transitory computer-readable storage medium according to claim 15, wherein the time-sensitive request for payment further comprises a response timing threshold defined by a maximum duration of time between receipt for the time-sensitive request for payment and a responsive authorization from the first user device.

19. The non-transitory computer-readable storage medium according to claim 18, wherein the computer-executable instructions, when executed, cause the apparatus to transmit the payment failure notification to the service provider device in an instance in which the responsive authorization from the first user device fails to satisfy the response timing threshold.

20. The non-transitory computer-readable storage medium according to claim 18, wherein the computer-executable instructions, when executed, cause the apparatus to transmit the payment failure notification to the service provider device in an instance in which the responsive authorization from the first user device fails to satisfy a payment threshold.

21. The method of claim 1, wherein the time-sensitive request for payment does not include one or more account parameters necessary to generate the actionable payment notification.

22. The apparatus of claim 8, wherein the time-sensitive request for payment does not include one or more account parameters necessary to generate the actionable payment notification.

23. The non-transitory computer-readable storage medium according to claim 15, wherein the time-sensitive request for payment does not include one or more account parameters necessary to generate the actionable payment notification.
